(19) United States
(12) Patent Application Publication
(10) Pub. No.: US 2007/0156548 A1
(43) Pub. Date: Jul. 5, 2007

(54) Systems and methods for minimizing financial loss in a business via article protection

(76) Inventor: Robert David Castagno, Warren, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(21) Appl. No.: 11/299,977

(22) Filed: Dec. 9, 2005

(51) Int. Cl. G06Q 40/00

(52) U.S. Cl. 705/35

(57) ABSTRACT

Disclosed are systems and methods for minimizing loss to a service business via article protection. In one aspect of the invention, protectors manufactured from a flexible, chemical-resistant material are provided. A client may place his personal possessions in the protector while receiving goods or services that may potentially damage or soil his possessions. Additionally, the protectors may include classification devices, color codes, marks, identification indicia, advertising, and the like to increase the utility thereof. In another aspect of the present invention, a method of minimizing financial loss via the use of protectors is provided. Upon entering a business location for a desired good or service, a client may be provided with a protector for placement of his personal items. The goods or services may then be provided without risk to the personal items, which may be removed from the protector after the goods and/or services have been received.

### BACKGROUND OF THE INVENTION

Embodiments of the present invention generally relate to systems and methods for minimizing financial loss in a business such as a service business. More specifically, the present invention relates to systems and methods for protecting a client's possessions from damage, soiling, theft, and the like while receiving goods or services from a business such as a spa or salon.

Many services provided by businesses such as nail salons, hair salons, and spas involve the use of chemicals or other damaging substances (e.g., coffee) that may cause damage to a client's personal possessions (e.g., handbags, purses, wallets, sweaters, coats, jackets, cell phones, etc.) if such chemicals or substances physically contact such possessions. In many instances in which a client's personal possessions are damaged or soiled, the client expects to be reimbursed by the business for the cost of the damaged or soiled article. The business' failure to reimburse the client for such damage or soiling may result in the loss of a client or a lawsuit. Therefore, whereas such reimbursements may retain the client or avoid a lawsuit, they result in financial loss to the business. Conversely, if the business refuses to reimburse the client, it is likely to experience a financial loss due to loss of future business from the client, cost of legal counsel for defense of a lawsuit, and/or potential payment of damages if the client prevails in the lawsuit. Depending upon the frequency of such occurrences and the financial loss associated with each occurrence, the cumulative financial loss to the business may severely reduce the business' profit and potentially bankrupt the business.

In addition to the financial implications of damaging a client's personal possessions, such occurrences affect the client's opinion regarding the quality of the goods and services provided by the business and, therefore, the business' reputation and goodwill. In many instances, clients regard a trip to a business such as a spa or salon as a relaxing experience after which a client expects to feel relaxed and rejuvenated. Damage to a client's personal possessions tend to create tension or stress that deteriorates the overall experience of the spa or salon, regardless of whether the business reimburses the client for the loss or damage. Consequently, even if restitution is made for the damaged item, it is likely that the client may not return to the business or may disparage the quality of the business to others, thereby resulting in a further loss of profit for the business.

Consequently, it is advantageous for a business to prevent a client's personal possessions from contacting chemicals or other damaging substances. However, it is often difficult to do so. First, the business may not have sufficient square footage to accommodate storage of the clients' personal possessions in areas not exposed to such chemicals or damaging substances. Second, even if a business offers storage for the clients' possessions, many clients would refuse such storage for fear of theft, or out of a desire to maintain their possessions in close proximity (e.g., a client may not store a cell phone out of fear that he or she will miss a telephone call). Third, articles such as handbags, purses, and the like are often viewed as status symbols. As such, an owner of such items has a desire to be seen or associated with the item, and will not store the item in an unseen location. This may be especially true for salons, spas, and the like given the nature of their business and the fact that the business itself may have been selected due to its reputation as a status symbol. For the aforementioned reasons and many more not mentioned, it is advantageous to allow a client to retain her possessions in close proximity while protecting such possessions from damage or soiling due to chemicals and/or other damaging substances.

### BRIEF SUMMARY OF THE INVENTION

Briefly stated, in one aspect of the present invention, an apparatus is disclosed for protecting at least one item belonging to at least one client of a business including at least two side panels attached to each other at two opposing sides, at least one aperture located between the opposing sides, and at least one closing mechanism coupled to the aperture and capable of closing the aperture, wherein the apparatus protects at least one item and minimizes financial loss to the business.

Also disclosed is a method for protecting at least one item belonging to at least one client of a business including distributing a protective apparatus to at least one client of the business, placing at least one item belonging to at least one client in the protective apparatus, closing or sealing the protective apparatus, providing at least one of a good, a service, and combinations thereof to the client, and removing at least one item from the protective apparatus after provision of at least one of a good, a service, and combinations thereof to the client, wherein the method protects at least one item and minimizes financial loss to the business.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 depicts a see-through article protector in accordance with one embodiment of the present invention.

FIG. 2 depicts an article protector worn by a user as a purse in accordance with one embodiment of the present invention.

FIG. 3 depicts an article protector equipped with a security strip worn by a client passing through a security strip detection unit in accordance with one embodiment of the present invention.

FIG. 4 depicts a stand for dispensing and/or securing one or more article protectors in accordance with one embodiment of the present invention.

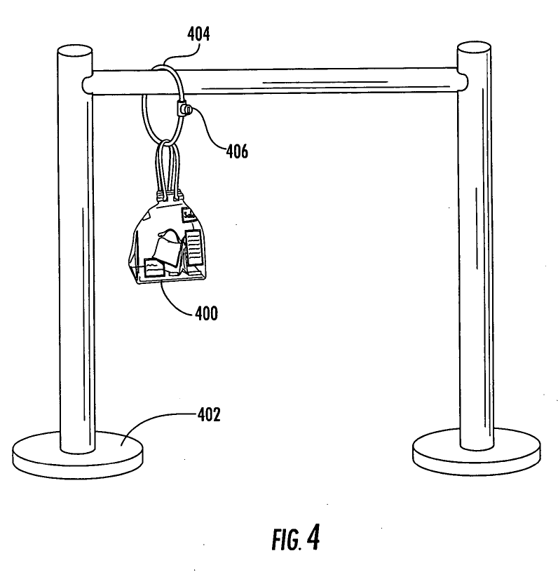

FIG. 5 depicts a flowchart of a method of minimizing loss for a business via article protection in accordance with one embodiment of the present invention.

### DETAILED DESCRIPTION OF THE INVENTION

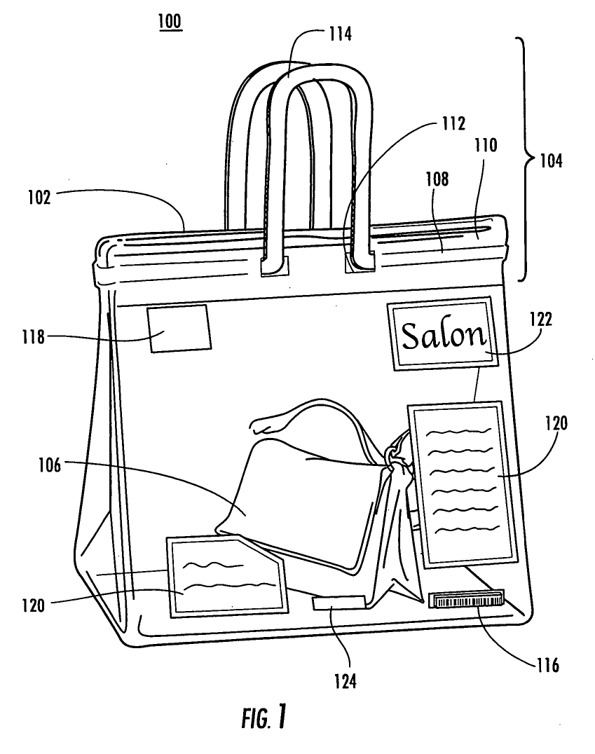

Referring first to FIG. 1, depicted is article protector 100 in accordance with one embodiment of the present invention. Article protector 100 may be used for protection of a client's personal possessions such as a handbag, purse, wallet, cell phone, sweater, coat, jacket or the like during provision of goods or services to a client that subjects such possessions to damage by chemicals or other damaging substances. For example, a client may place her articles in article protector 100 while undergoing a chemical treatment (e.g., hair coloring, artificial nails, etc.) at a business such as a salon or spa. Placement of the articles in article protector 100 ensures that chemicals and other damaging substances will not contact the handbag or other articles placed within article protector 100. Such protection eliminates, or at least minimizes, the financial loss suffered by businesses for replacement and/or cleaning of damaged or soiled articles, lost business due to the client's failure to use the business in the future, and degradation of the business' reputation by the affected client.

In one aspect of the present invention, article protector 100 is manufactured from a flexible, chemical-resistant material. For example, article protector 100 may be manufactured from a polymer such as polyethylene. Use of such a material results in clear, soft, flexible, sanitary article protectors 100 that are resistant to water, acids, alkalies, and a majority of solvents. Also, use of such a material allows article protectors 100 to be produced inexpensively. The inexpensive cost of article protector 100 accommodates distribution thereof in facilities such as salons and spas. In addition, the use of a flexible material allows article protectors 100 to be folded such that they may be easily stored in virtually any location. However, materials other than polymers or polyethylene may be substituted without departing from the scope hereof.

It is also advantageous to manufacture the article protectors of the present invention using clear or see-through materials for a variety of reasons. First, the use of a clear material allows a client to see the contents of article protector 100 without having to open the article protector and potentially expose the contents to chemicals or other damaging substances. Second, clear article protectors 100 allow others to see the contents of the client's article protector 100, thereby allowing the client to display status symbol articles such as handbags, purses, and the like. Third, see-through articles minimize the potential for a client to accidentally or purposely leave the business location with the wrong article protector (and the enclosed contents).

In one aspect of the present invention such as that depicted in FIG. 1, article protector 100 includes, inter alia, opening 102 and closing mechanism 104. When protection is required for an article such as handbag 106, it may be placed within article protector 100 by passing it through opening 102.

After placement of the desired articles within article protector 100, it may be closed via a closing mechanism such as closing mechanism 104 to prevent debris, chemicals, and other damaging substances from entering article protector 100 and contacting the enclosed articles. In the depicted embodiment of the present invention, closing mechanism 104 includes drawstring 108, drawstring channel 110, drawstring apertures 112, and handles 114.

Although FIG. 1 depicts drawstring 108 as a woven rope, it may be fabricated from other materials without departing from the scope of the present invention. For example, drawstring 108 may be fabricated from any one of a variety of polymers, plastics, or fabrics to for purposes such as minimizing the weight and/or cost of article protector 100 and the like.

In some embodiments of the present invention, drawstring channel 110 is located around the perimeter of opening 102. Drawstring 108 passes through drawstring channel 110 and exits article protector 100 via drawstring apertures 110. In one aspect of the present invention, drawstring apertures are located at both ends of drawstring channel 110 through its inwardly facing surface. Such location allows the portion of drawstring 108 external to drawstring channel 110 to be located within article protector 100 to prevent debris, chemicals, and other damaging substances from contacting drawstring 108. Such protection minimizes the possibility that a client will touch chemicals or other damaging substances on drawstring 108 while opening article protector 100 and transfer such chemicals or substances to the articles contained therein, thereby damaging or soiling the articles.

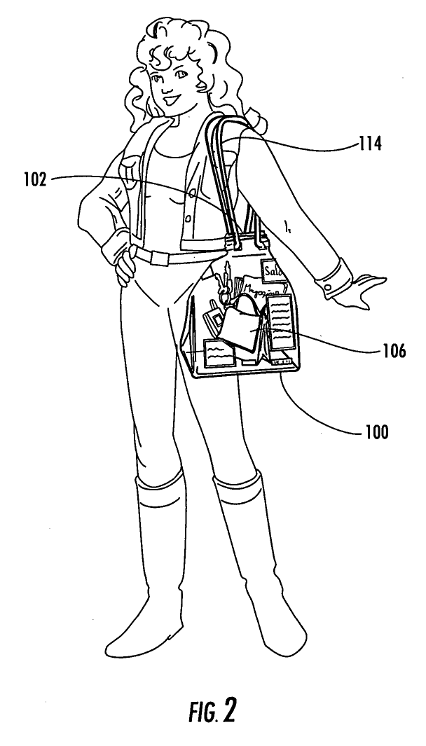

In some embodiments of the present invention, the portions of drawstring 108 located external to drawstring channel 110 form handles 114. In such embodiments, pulling upwardly on handles 114 causes drawstring 108 to be pulled taut, closing opening 102. Incorporation of handles 114 allows them to be used as purse straps when article protector 100 is closed (i.e., and the length of handles 114 is sufficient to hang on the client's shoulder), thereby allowing article protector 100 to be carried as a purse. When article protector 100 is distributed to clients of a business such as a nail salon, it allows each client to place her belongings in article protector 100 and hang the article protector 100 on her shoulder prior to a nail treatment such as application of nail polish or the like as depicted in FIG. 2. This allows the client to easily leave the nail salon with her belongings without touching her articles, thereby minimizing the risk that the client will damage the nail treatment (e.g., application of nail polish). Furthermore, use of article protector 100 as a purse ensures that the client will remember to close opening 102 of article protector 100 since handle 114 will not be of sufficient length to accommodate such use unless opening 102 is closed.

Use of a closing mechanism such as closing mechanism 104 also facilitates hanging of article protector 100 on items other than a client's shoulder. Once drawstring 108 is pulled taut, handles 114 may be passed over the arm or back of the client's chair, a drawer knob of a salon station, an arm of a coat rack, and the like. Such use provides additional utility for article protector 100 as it allows a client to store a sweater or similar article that she does not want to store on a hanger (e.g., due to fear of stretching, soiling, damage, theft, or the like) and/or in a remote location to be stored in article protector 100 in close proximity, or in a remote location, without risk of damage from a hanger.

However, closing mechanisms other than closing mechanisms 104 may be substituted without departing from the spirit of the present invention. For example, closing mechanisms may include snaps, buttons, Velcro, zippers, and the like. However, incorporation of a relatively simplistic closing mechanism such as closing mechanism 104 reduces the cost of implementing the systems and methods of the present invention to maximize the profitability of the business.

In embodiments of the present invention in which a hanging mechanism is not integral to the closing mechanism, article protector 100 will optimally include a separate and distinct hanging mechanism such as hooks, loops, handles, straps, or the like. In addition to the benefits of such a feature as discussed above, incorporation of a hanging mechanism provides a means of storing the article protectors while not in use. For example, article protectors such as article protector 100 may be stored on a stand or the like at the entrance of a business location.

In another aspect of the present invention, article protector 100 includes a classification mechanism such as color code 118. Color code 118 may be color-coded indicia preprinted on article protector 100. Alternatively, non-color coded classification mechanisms such as images, employee names, or the like may be substituted without departing from the scope of the present invention. Such classification mechanism may be applied during manufacturing of the article protector or may be one or more color-coded stickers or the like added to article protector 100 post-manufacturing. Furthermore, such classification mechanisms may be applied post-manufacturing by business employees on a per client basis.

Use of such a classification mechanism allows employees of the business to determine the type of goods and/or services desired by a customer without inquiring into same. Such determinations allow the employee to easily and quickly assist the client by directing them to the proper area within the business location, to the desired employee, etc. Such a feature is particularly useful when a client is seeing an employee for the first time and, therefore, the client and the employee cannot recognize each other without assistance. Such a feature masks the fact that the client is new or infrequently visits the business location, thereby increasing the client's sense of importance and potentially her overall experience.

Advertisements such as advertisements 120 may also be included in some embodiments of the present invention. A business that distributes article protectors such as article protectors 100 may include advertising for purposes such as reducing the cost of distributing such article protectors 100, increasing the revenue of the business, increasing sales of the business' goods and/or services, and the like. Such advertising may be sold to third parties or may be advertising of the business' own goods and services. Similarly, article protectors may include other indicia such as mark 122 and identifier 124. For example, mark 122 may be a business name, logo, slogan, or the like. Placement of a mark such as mark 122 on the article protector increases the visibility of the mark, thereby enhancing it.

Inclusion of an identifier such as identifier 124 allows repeat clients to reuse a dedicated article protector in which contents may be left for storage at the business location between client visits. This may be advantageous if a client desires dedicated equipment (e.g., nail files, cuticle trimmers, etc.) for hygienic or other purposes. Similarly, a user may want to leave protective eyewear (e.g., eyewear for use in a tanning booth), towels, magazines, or the like at a salon or spa. The ability to store such items at the business location eliminates the problems associated with the client forgetting to bring needed items. In such embodiments of the present invention, article protector 100 functions as a private locker for the client without requiring the area typically associated with such lockers.

The benefits of placing advertisements such as advertisements 120 and/or marks such as marks 122 on the article protector are increased when the clients are allowed to leave the business location with the article protector, thereby exposing the advertisements and/or marks to the public. Allowing a client to leave the business location with the article protector also increases the utility of the present invention by allowing the client to protect his or her possessions from the weather. For example, if it is raining or snowing when the user leaves the business location, articles that may be damaged by the weather (e.g., suede articles) may remain in the article protector until the client returns to his or her home or until the weather clears. Or, after leaving the salon, a client may wish to continue to use the bag as a status symbol.

Additionally, article protectors such as article protector 100 may include features that prevent theft of article protector 100. In one embodiment of the present invention, one theft prevention mechanism is simply the material from which the article protector is constructed. For example, construction of the article protector from a semi-rigid polymer causes the bag to crinkle when moved, opened, or closed. Such crinkling may alert a nearby user of the article protector that someone has attempted to access the objects in his or her article protector, thereby allowing them to prevent the theft or recover the enclosed articles.

Similarly, the closing mechanism of the article protector may be such that only business employees having the proper tools may open it. Such article protectors would render the theft of the article protector useless, unless the thief had access to the required opening tool(s). In a simplistic version of this feature, the article protector is simply tied closed, thereby requiring breaking the tie or the like to access the contents of the bag.

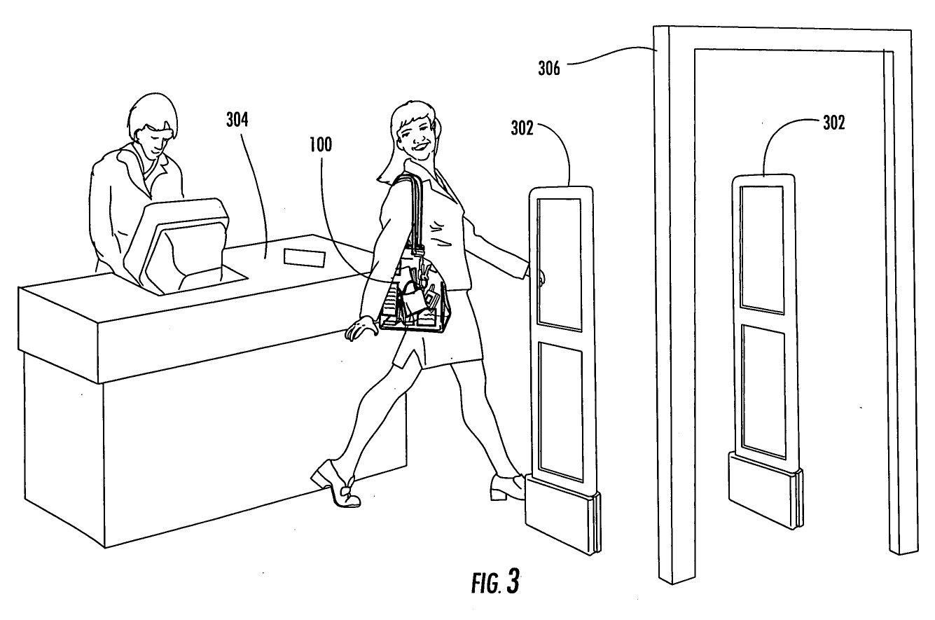

Alternatively, as depicted in FIG. 3, article protectors may be secured via use of a security device such as security strip 116. Security strip 116 may be any commercially know security strip that is activated by passing through or beyond preset boundary 302. For example, security strip 116 may cause an alarm to sound if an article protector such as article protector 100 is taken past payment counter 304 or through door 306 of the business location. Preferably, security strip 116 is capable of being deactivated. For instance, if a client wishes to keep his or her article protector 100 after leaving the business location, a business employee may simply deactivate security strip 116 (potentially after checking the contents of the article protector) to allow the client to pass through or beyond the barrier without incident.

In yet another embodiment of a theft prevention feature, a stand such as stand 402 is provided. In one such embodiment, article protector 400 is removeably attached to stand 402 via cord 404, however, it requires an unlocking mechanism such as unlocking mechanism 406 to remove article protector 400 therefrom. Unlocking mechanism 406 may require a key, code, or the like to allow removal of article protector 400. In another such embodiment, article protector 400 is removeably attached to the stand and would include an unlocking mechanism for both removing article protector 400 from stand 402 and opening thereof. Additionally, the locating of stands such as stands 400 in various locations within the business locations advertises the apparatus protection service, thereby potentially enticing clients to request it or even pay additional fees for its use.

Although the embodiment of the present invention depicted in FIG. 1 depicts an article protector 100 used for protection of a handbag, the article protector of the present invention may be used to protect virtually any type of personal possession (e.g., wallet, sweater, coat, jacket, book, magazine, umbrella, keys, etc.).

Furthermore, although FIG. 1 depicts article protector as a plastic bag, other methods of protecting articles may be substituted without departing from the scope hereof. Such substitutions may include, for example, boxes, paper bags, fabric bags or containers, etc.

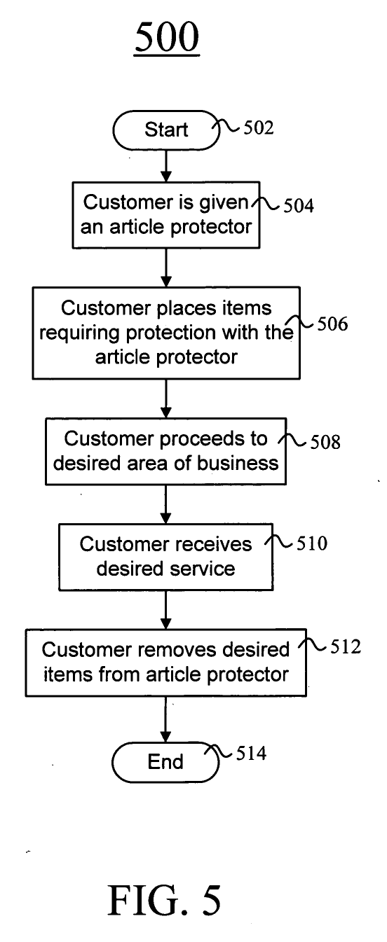

Referring now to FIG. 5, depicted is a flowchart of one method 500 of minimizing loss to a business via use of article protection in accordance with the present invention. Method 500 begins at 502 with a customer entering a business location such as a salon or spa. Method 500 then proceeds to 504, at which, upon arrival at the business location, a customer may be provided with a new article protector. Alternatively, a repeat customer may be given a dedicated article protector that was stored during a previous visit by the client to the business location. In the latter scenario, article protector may include a method of identification such as nametag 124 (FIG. 1).

After receipt of the article protector at 504, method 500 proceeds to 506 at which the customer places the items for which protection is desired into the article protector. At 508, the customer then proceeds to the area of the business location in which the desired goods or services will be distributed and/or performed, respectively. In some scenarios, he or she may maintain the article protector in close proximity to provide easy access to the items contained in the article protector while minimizing the potential for such items being soiled, damaged, or stolen.

Optionally, at 508, after a client has received his or her article protector, such client may be directed to a waiting area and a business employee may retrieve the client and escort him to the proper location or proper employee within the business location without inquiry related thereto. Or, alternatively, such client may be automatically recognized by the employee from whom the client will receive goods or services without inquiry related thereto. Such a feature typically leads to increased customer satisfaction by masking the fact that the client is new or infrequently visits the business location, thereby increasing the client's sense of importance and potentially her overall experience.

Method 500 the proceeds to 510 at which the customer receives the desired service. Once the desired service is complete or the goods are received, method 500 proceeds to 512 at which the customer may remove his or her items from the article protector prior to leaving the business location. Or, alternatively, he or she may retain the article protector upon leaving the business location for purposes such as protection of the enclosed items from the weather or the like. Or, alternatively, at 512 the customer may leave some articles in the article protectors and provide them to the business for storage until the client's next visit. In this scenario, the customer can be assured that their items will be maintained in a safe and sanitary place and she does not have the worry that the items may be forgotten on her next visit. Method 500 then terminates at 514 at which the customer departs from the place of business.

Incorporation of the systems and/or methods of the present invention provide a business' clients with a sense of security about their belongings, while minimizing financial loss to the business. In many instances in which a client's personal possessions are damaged or soiled, the client expects to be reimbursed by the business for the cost of the damaged or soiled article. Prevention of such damage or soiling minimizes the business's financial exposure while retaining its client, maintaining or increasing its goodwill and reputation, and avoiding the unnecessary expense of related lawsuits.

Although the use of the article protectors of the present invention has been described primarily with respect to salons and spas, the article protectors of the present invention are not so limited. Article protectors may be used to protect virtually any items in any situation that presents a hazard to the items. For example, article protectors may be used at a restaurant to prevent accidental spillage or consumption of messy foods (e.g., consumption and cracking of whole lobsters) from damaging a customer's belongings. Other places in which article protectors may be required include, but are not limited to, bars, amusement parks, zoos, pools, billiard rooms, bowling alleys, boats, ballparks, stadiums, and playgrounds.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An apparatus for protecting at least one item belonging to at least one client of a business comprising:
at least two side panels attached to each other at two opposing sides;
at least one aperture located between said opposing sides; and
at least one closing mechanism coupled to said aperture and capable of closing said aperture;
wherein said apparatus protects said at least one item and minimizes financial loss to said business.

2. An apparatus according to claim 1, further comprising:
at least one bottom panel;
wherein said bottom panel is located between said opposing sides opposite of said aperture.

3. An apparatus according to claim 1, wherein said apparatus is manufactured from a material selected from the group consisting of a polymer, polyethylene, plastic, rubber, fabric, and combinations thereof.

4. An apparatus according to claim 1, wherein said apparatus is manufactured from a semi-rigid material such that opening, closing, or moving said apparatus creates an audible sound.

5. An apparatus according to claim 1, wherein said apparatus is manufactured from a material selected from group consisting of soft, flexible, sanitary, chemical-resistant, water-resistant, washable, inexpensive, and combinations thereof.

6. An apparatus according to claim 1, further comprising:
at least one security mechanism;
wherein said security mechanism prevents at least one of the group consisting of removal of said apparatus from said business, removal of said apparatus from a stand, removal of said at least one item from said apparatus, and combinations thereof.

7. An apparatus according to claim 1, further comprising:
at least one stand providing at least one of the group consisting of display, storage, security, and combinations thereof.

8. An apparatus according to claim 1, wherein said closing mechanism is at least one of the group consisting of a drawstring, Velcro®, a zipper, snaps, buttons, hooks, ties, and combinations thereof.

9. An apparatus according to claim 1, further comprising:
at least one hanging mechanism selected from the group consisting of at least one strap, at least one hook, at least one loop extension, and combinations thereof.

10. An apparatus according to claim 9, wherein placement of said hanging mechanism atop a shoulder of a user of said apparatus allows said apparatus to be carried hands-free.

11. An apparatus according to claim 1, further comprising:
at least one classification mechanism.

12. An apparatus according to claim 11, wherein said classification mechanism indicates at least one of the group consisting of a good to be provided to said client, a service to be provided to said client, a goods provider, a service provider, a specific portion of a location of said business, and combinations thereof.

13. An apparatus according to claim 11, wherein said classification mechanism is color-coded.

14. An apparatus according to claim 1, further comprising:
at least one advertisement.

15. An apparatus according to claim 1, further comprising:
at least one indicia.

16. An apparatus according to claim 15, wherein said at least one indicia is selected from the group consisting of a name of said business, a name of a business other than said business, a logo of said business, a logo of said business other than said business, a slogan of said business, a slogan of said business other than said business, a trademark or service mark of said business, a trademark or service mark of said business other than said business, a name of one of said clients, a name of an employee of said business, a service provided by said business, a good provided by said business, and combinations thereof.

17. An apparatus according to claim 1, wherein provision of at least one of the group consisting of a good provided by said business, a service provided by said business, and combinations thereof subjects said at least one item to at least one of the group consisting of damage, soiling, and combinations thereof.

18. An apparatus according to claim 1, wherein said financial loss to said business includes at least one of the group consisting of a replacement cost of said at least one item, a cleaning cost of said at least one item, loss of future revenue from said client due to said client's failure to repatronize to said business, loss of said future revenue due to failure of persons other than said client to patronize said business due to degradation of the reputation of said business, and combinations thereof.

19. An apparatus according to claim 1, wherein said apparatus is transparent.

20. An apparatus according to claim 1, wherein said closing mechanism is located internal to said at least two side panels.

21. A method for protecting at least one item belonging to at least one client of a business comprising:
distributing a protective apparatus to at least one client of said business;
placing said at least one item belonging to said at least one client in said protective apparatus;
closing or sealing said protective apparatus;
providing at least one of a good, a service, and combinations thereof to said client; and
removing said at least one item from said protective apparatus after provision of said at least one of a good, a service, and combinations thereof to said client;
wherein said methods protects said at least one item and minimizes financial loss to said business.

22. A method according to claim 21, wherein provision of at least one of the group consisting of a good provided by said business, a service provided by said business, and combinations thereof subjects said at least one item to at least one of the group consisting of damage, soiling, and combinations thereof.

23. A method according to claim 21, wherein opening, closing, or moving said apparatus creates an audible sound.

24. A method according to claim 21, further comprising:
automatically notifying at least one employee of said business upon movement of said protective apparatus beyond at least one preset boundary.

25. A method according to claim 21, further comprising:
carrying said protective apparatus hands-free.

26. A method according to claim 21, further comprising:
indicating at least one of the group consisting of a good to be provided to said client, a service to be provided to said client, a goods provider, a service provider, a specific portion of a location of said business, and combinations thereof to at least one employee of said business.

27. A method according to claim 26, further comprising:
leading said client to at least one of the group consisting of at least one of said at least one employee of said business, at least one portion of a location of said business, and combinations thereof based upon said indication.

28. A method according to claim 21, further comprising:
advertising said business, said good, said service, a business other than said business, a good other than said good of said business, a service other than a service of said business, and combinations thereof.

29. A method according to claim 21, wherein said financial loss to said business includes at least one of the group consisting of a replacement cost of said at least one item, a cleaning cost of said at least one item, loss of future revenue from said client due to said client's failure to repatronize to said business, loss of said future revenue due to failure of persons other than said client to patronize said business due to degradation of the reputation of said business, and combinations thereof.

30. A method according to claim 21, wherein said protective apparatus is transparent.

31. A method according to claim 21, further comprising:
storing said at least one item for said client for use upon return of said client to said business.
